(19) United States
(12) Patent Application Publication
(10) Pub. No.: US 2024/0362069 A1
(43) Pub. Date: Oct. 31, 2024

(54) RESOURCE ALLOCATION METHOD AND RESOURCE ALLOCATION APPARATUS

(71) Applicant: HANGZHOU ALICLOUD FEITIAN INFORMATION TECHNOLOGY CO., LTD., HANGZHOU CITY, YUHANG DISTRICT (CN)

(72) Inventors: Fansong ZENG, Beijing (CN); Menghai WANG, Beijing (CN); Tao LI, Beijing (CN); Tao HUANG, Beijing (CN)

(21) Appl. No.: 18/685,183

(22) PCT Filed: Oct. 8, 2022
(86) PCT No.: PCT/CN2022/123900

§ 371 Date: Feb. 20, 2024

(30) Foreign Application Priority Data
Oct. 18, 2021 (CN) 202111210713.7

(51) Int. Cl. G06F 9/50

(52) U.S. Cl. CPC G06F 9/5027

(57) ABSTRACT

Provided in the present application are a resource allocation method and apparatus. The resource allocation method comprises: acquiring resource usage data corresponding to work loads; according to the resource usage data, constructing a long-period resource feature map corresponding to a long-period load type, and a short-period resource feature map corresponding to a short-period load type; according to the short-period resource feature map, allocating, from resources to be allocated, short-period resources for the short-period load type; and according to the long-period resource feature map, allocating, from the short-period resources, long-period resources for the long-period load type.

The present application claims priority to Chinese patent application No. 202111210713.7, filed with the China Patent Office on Oct. 18, 2021 and entitled “RESOURCE ALLOCATION METHOD AND APPARATUS”, which is incorporated herein by reference in its entirety.

### TECHNICAL FIELD

The present application relates to the field of computer technology, and in particular to a resource allocation method and apparatus, a computing device, and a storage medium.

### BACKGROUND

With the development of Internet technology, resource schedulers that serve cloud products have become an indispensable part. In the related technologies, resource schedulers all employ a request-based static resource model. The entire system collects total resources of each node and calculates the number of resource requests loaded at the node according to requests described by a user. However, this may lead to significant waste of resources. A main reason is that the requests applied for by the user may be much greater than actual resource needs. For large-scale machines with a very great number of applications, the applications cannot be managed manually. Even for very experienced application developers, when facing complex service scenarios and diverse infrastructures, it is also difficult to accurately estimate the quantity of resources as needed, which then brings about considerable waste of resources. Secondly, due to severe resource fragmentation and limitations of matching the rule of a single machine with the size of a single request, there may be some fragmented resources that cannot be utilized on each machine, which then leads to the impossibility to ensure a resource utilization rate in heterogeneous scenarios. Therefore, an effective solution is urgently needed to solve the above problems.

### SUMMARY

In view of this, an embodiment of the present application provides a resource allocation method. Meanwhile, one or more embodiments of the present application relate to a resource allocation apparatus, a computing device, a computer readable storage medium, and a computer program, so as to solve the technical defects existing in the related technologies.

According to a first aspect of the embodiments of the present application, there is provided a resource allocation method, comprising: acquiring resource usage data corresponding to work loads; constructing, according to the resource usage data, a long-period resource feature map corresponding to a long-period load type, and a short-period resource feature map corresponding to a short-period load type; according to the short-period resource feature map, allocating, from resources to be allocated, short-period resources for the short-period load type; and according to the long-period resource feature map, allocating, from the short-period resources, long-period resources for the long-period load type.

According to a second aspect of the embodiments of the present application, there is provided a resource allocation apparatus, comprising: an acquisition module, configured to acquire resource usage data corresponding to work loads; a construction module, configured to construct, according to the resource usage data, a long-period resource feature map corresponding to a long-period load type, and a short-period resource feature map corresponding to a short-period load type; a first allocation module, configured to, according to the short-period resource feature map, allocate, from resources to be allocated, short-period resources for the short-period load type; and a second allocation module, configured to, according to the long-period resource feature map, allocate, from the short-period resources, long-period resources for the long-period load type.

According to a third aspect of the embodiments of the present application, there is provided a computing device, comprising: a memory, used for storing computer-executable instructions; and a processor, used for executing the computer-executable instructions to acquire resource usage data corresponding to work loads; construct, according to the resource usage data, a long-period resource feature map corresponding to a long-period load type, and a short-period resource feature map corresponding to a short-period load type; according to the short-period resource feature map, allocate, from resources to be allocated, short-period resources for the short-period load type; and according to the long-period resource feature map, allocate, from the short-period resources, long-period resources for the long-period load type.

According to a fourth aspect of the embodiments of the present application, there is provided a computer-readable storage medium, which stores computer-executable instructions that, when executed by a processor, implement steps of any resource allocation method.

According to a fifth aspect of the embodiments of the present application, there is provided a computer program, wherein the computer program, when executed in a computer, causes the computer to execute steps of the resource allocation method described above.

The above summary is only for the purpose of the illustration, and is not intended to make limitations in any way. In addition to the illustrative aspects, implementations, and features described above, further aspects, implementations, and features of the present application will become apparent with reference to the drawings and the following detailed description.

According to the resource allocation method provided in the present application, after resource usage data corresponding to work loads is acquired, it is possible to construct, on this basis, a long-period resource feature map corresponding to a long-period load type and a short-period resource feature map corresponding to a short-period load type, thereby achieving that resource demands of different types of work loads are reflected by resource feature maps, then short-period resources are allocated for the short-period load type according to the short-period resource feature map, and after resources are all allocated, long-period resources are oversold for the long-period task load type according to the long-period resource feature map; and achieving that resource allocation of any task is supported by unification processing, which may not only ensure requirements for resource certainty of various services, but also improve the resource utilization rate of a data center by means of resource overselling, thereby effectively reducing losses brought about by resource waste.

### BRIEF DESCRIPTION OF THE DRAWINGS

FIG. 1 is a schematic diagram of resource allocation according to an embodiment of the present application.

FIG. 2 is a flow chart of a resource allocation method according to an embodiment of the present application.

FIG. 3 is a schematic diagram of a resource feature map in a resource allocation method according to an embodiment of the present application.

FIG. 4 is a schematic diagram of allocation processing for resources in a resource allocation method according to an embodiment of the present application.

FIG. 5 is a schematic diagram of allocation processing for long-period resources in a resource allocation method according to an embodiment of the present application.

FIG. 6 is a schematic diagram of allocation processing for calling resources in a resource allocation method according to an embodiment of the present application.

FIG. 7 is a flow chart of a processing course in a resource allocation method according to an embodiment of the present application.

FIG. 8 is a structural schematic diagram of a resource allocation apparatus according to an embodiment of the present application.

FIG. 9 is a structural block diagram of a computing device according to an embodiment of the present application.

### DETAILED DESCRIPTION

Many specific details will be elaborated in the following description to facilitate a full understanding of the present application. However, the present application can be implemented in many other ways different from those described here, and those skilled in the art may conduct similar extensions without going against the connotation of the present application. Thus, the present application is not limited by the specific implementations disclosed below.

Terms used in one or more embodiments of the present application are only for the purpose of describing particular embodiments, and are not intended to limit one or more embodiments of the present application. Singular forms “a/an”, “the” and “this” used in one or more embodiments of the present application and the attached claims are also intended to include the plural forms, unless otherwise clearly indicated in the context. It should also be understood that the term “and/or” used in one or more embodiments of the present application refers to and includes any or all possible combinations of one or more associated items as listed.

It should be understood that although various information may be described employing terms such as first and second in one or more embodiments of the present specification, such information should not be limited to these terms. These terms are only used for distinguishing information of the same type from each other. For example, without departing from the scope of one or more embodiments of the present application, the term “first” may also be referred to as “second”, and similarly, “second” may also be referred to as “first”. Depending on the context, the word “if” used here may be interpreted as “when” or “as” or “to determine . . . in response to . . . ”

First, nouns or terms involved in one or more embodiments of the present application are explained.

Work load refers to an application running in a data center, including online services that process user requests in real time, back-end batch-processed computing tasks, AI training and inference, etc.

Scheduling arrangement refers to a process of placing work loads on a limited number of computers in the data center to complete corresponding data processing, including selection of computers at a current moment and selection of an order of work loads.

Resource model refers to a paradigm of using cluster resource, such that all work loads running in a cluster adhere to this normative constraint, which is a core abstraction in cluster resource scheduling.

PriorityClass is used to represent a priority class of a task, where tasks of the same level may employ the same processing method in scheduling, and takes of different types may employ different processing methods in scheduling.

In the present application, there is provided a resource allocation method. Meanwhile, the present application also relates to a resource allocation apparatus, a computing device, and a computer-readable storage medium. In the following embodiments, the resource allocation apparatus, computing device, and computer-readable storage medium of the present application will be described in detail.

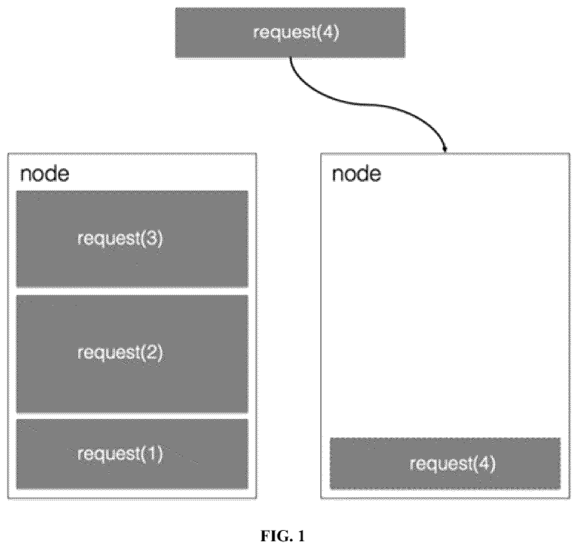

In actual applications, a resource scheduler may employ yarn, mesos or kubernetes to support scheduling arrangement, and needs to meet Σᵢ request (i)≤Allocable_{node} when calculating the number of resource requests that may be loaded at each node. By referring to the schematic diagram of request allocation shown in FIG. 1, when request (4) arrives, it can only be placed at a new node, even though an actual utilization rate of the current node may be very idle, which leads to more waste of resources. In related technologies, integer programming is mostly used to mitigate a fragmentation problem caused by multi-dimensional resource packaging. However, this provides very little room for improving the cluster resource utilization rate.

Yarn supports further scheduling tasks according to loads when a node is running, thereby improving the resource utilization efficiency of the node. Although Yarn has a model that is simple and suitable for a scenario of big-data batch-processed computing tasks that it faces, it lacks a solution coping with a long-lifecycle work load, and services of a long-lifecycle type are difficult to run thereon to coexist with a short-lifecycle work load.

Kubernetes supports a resource model called BestEffort, which allows users to over-allocate tasks to nodes. However, BestEffort tasks involve no resource description, making it difficult for the scheduler to select an appropriate machine, and there is no fairness guarantee between tasks, which leads to that tasks submitted through BestEffort cannot get relatively certain resource SLO guarantees, and are difficult to apply to real production environments.

In view of this, according to the resource allocation method provided in the present application, after resource usage data corresponding to work loads is acquired, it is possible to construct, on this basis, a long-period resource feature map corresponding to a long-period load type and a short-period resource feature map corresponding to a short-period load type, thereby achieving that resource demands of different types of work loads are reflected by resource feature maps, then short-period resources are allocated for the short-period load type according to the short-period resource feature map, and after resources are all allocated, long-period resources are oversold for the long-period task load type according to the long-period resource feature map; and achieving that resource allocation of any task is supported by unification processing, which may not only ensure requirements for resource certainty of various services, but also improve the resource utilization rate of a data center by means of resource overselling, thereby effectively reducing losses brought about by resource waste.

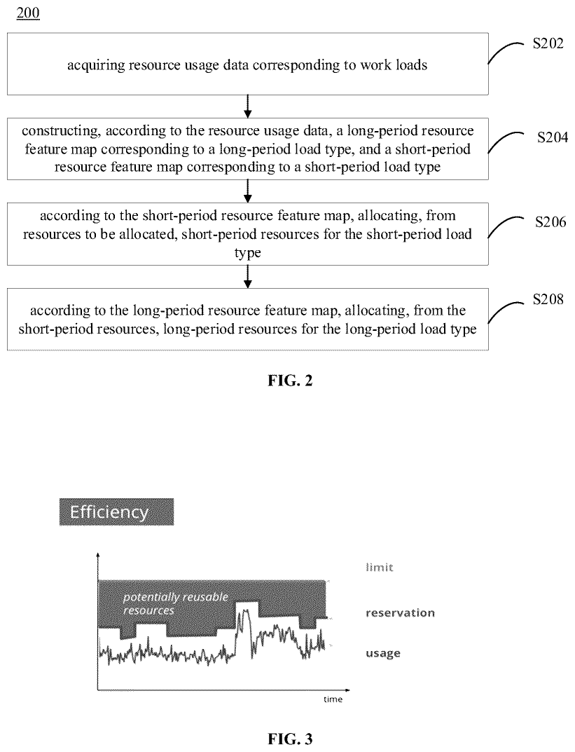

FIG. 2 shows a flow chart of a resource allocation method 200 according to an embodiment of the present application, which specifically comprises the following steps S202 to S208. The resource allocation method 200 will be described in detail below.
At step S202, resource usage data corresponding to a work load is acquired.

In an embodiment, the work load specifically may refer to an application running in a data center, which includes but is not limited to: an online service requested by a user, such as a service that may be called by clicking a button in a shopping APP; a back-end batch-processed computing task, such as tensorflow/pytorch, etc.; and a task of offline analysis type, such as a daily-level big data report, and a non-interactive SQL query. In other words, tasks that need to be processed by computers in the data center all may belong to the work load. Correspondingly, the resource usage data specifically may refer to data corresponding to historical resource usage of the work load within a preset period, to achieve subsequent implementation of resource allocation processing in conjunction with the resource usage data.

Based on this, in order to be able to subsequently allocate rational resources for different types of work loads, while improving the resource utilization rate of a server and avoiding resource waste, it is possible to first acquire resource usage data corresponding to work loads to facilitate subsequent implementation of resource allocation for different types of work loads on the basis of resource usage data.

It should be noted that different types of work loads may be different in usage of resources. For example, tasks of a real-time response type may need uninterrupted use of computer resources in the data center, while real-time computing tasks such as AI training may need to occupy part of the computer resources for a long time, and tasks of an offline analysis type may only need to use part of the computer resources at a particular time. Therefore, if resources are allocated separately for each type of task, this not only fails to guarantee the resource utilization rate, but also leads to resource waste. Therefore, prior to resource allocation, work loads may be classified according to a length of a period of their usage of resources when the work loads are running. Work loads that use computer resources for a long time belong to a long-period load type, and work loads that use computer resources for a short time belong to a short-period load type, so as to facilitate that subsequent allocation of resources may be completed starting from type, and resources may depend on each other during allocation to improve the resource utilization rate.

Next, proceed to step S204. At step S204, a long-period resource feature map corresponding to a long-period load type and a short-period resource feature map corresponding to a short-period load type are constructed according to the resource usage data.

In an embodiment, after the resource usage data corresponding to the work loads is acquired above, in order to be able to guarantee the rationality of resource allocation and improve the resource utilization rate, it is possible to construct, according to the resource usage data as acquired, a long-period resource feature map corresponding to a long-period load type and a short-period resource feature map corresponding to a short-period load type respectively, so as to facilitate that the usage of resources by different types of work loads may be determined by means of analyzing resource feature maps, so as to select a rational proportion to perform resource allocation from resources to be allocated.

The long-period load type specifically may refer to a type corresponding to a work load having a runtime greater than a preset threshold. Correspondingly, the short-period load type specifically may refer to a type corresponding to a work load having a runtime less than or equal to the preset threshold. The long-period resource feature map specifically may refer to an image that characterizes resource usage condition of a work load of the long-period load type within a certain time interval, and through the long-period resource feature map, it is possible to determine resource usage condition in each sub time interval, and a resource utilization rate in each node when a work load of this type is running. The short-period resource feature map specifically may refer to an image that characterizes resource usage condition of a work load of the short-period load type within a certain time interval, and through the short-period resource feature map, it is possible to determine resource usage condition at each moment, and a resource utilization in each node when a work load of this type is running.

In other words, the long-period resource feature map is used to characterize resource usage condition of a work load that runs for a longer time, and the short-period resource feature map is used to characterize resource usage condition of a work load that runs for a shorter time, so as to facilitate subsequent implementation of resource allocation for different types of work loads in conjunction with running duration, and characteristics of work loads with different running durations in resource usage are fully considered to guarantee rational resource allocation and a higher utilization rate.

In an embodiment, when constructing a resource feature map corresponding to a period load type based on the resource usage data, it is considered that the resource usage data includes resource usage data corresponding to different types of work loads, it is therefore necessary to select resource usage data for the corresponding period load type to implement construction of the resource feature map, which is specifically implemented from steps S2042 to S2046 as below.
At step S2042, initial resource usage data corresponding to a target time interval is selected from the resource usage data.
At step S2044, the initial resource usage data is processed according to a preset attenuation strategy to obtain short-period resource usage data.

In an embodiment, the target time interval is used to determine resource usage condition of a work load within this time interval, and the determined resource usage condition is the initial resource usage data. Correspondingly, the attenuation strategy specifically refers to a strategy of attenuation processing for the initial resource usage data within the target time interval, which is used to improve computing efficiency and reduce consumption of computing resources. Correspondingly, the resource usage data on which resource allocation depends specifically refers to data corresponding to sampled resource usage condition of a work load of a corresponding load type obtained after the attenuation processing.

Based on this, in order to be able to construct a resource feature map corresponding to this period load type through resource usage data corresponding to this period load type, the initial resource usage data corresponding to the target time interval may be selected in the resource usage data, and then the initial resource usage data is processed according to the preset attenuation strategy, to obtain the resource usage data corresponding to this period load type according to a processing result, so as to facilitate subsequent construction of the resource feature map corresponding to this period load type on this basis, and facilitate subsequent allocation of rational resources for the work load corresponding to this period load type.

In an embodiment, when the initial resource usage data is processed based on the preset attenuation strategy, sliding window statistical calculation is actually performed in a time attenuation manner, thereby obtaining resource usage data corresponding to this period load type. In this embodiment, the specific implementation is as follows:
performing sampling processing on the initial resource usage data at each time node in the target time interval to obtain a plurality of initial resource usage values; determining an attenuation value corresponding to the target time interval, and processing the plurality of initial resource usage values according to the attenuation value; and determining the short-period resource usage data according to a processing result.

In an embodiment, the plurality of initial resource usage values specifically may refer to resource usage values obtained after sampling at each time node in the target time interval. Correspondingly, the attenuation value specifically may refer to a numerical value corresponding in batch to half-life.

Based on this, in order to be able to subsequently construct a resource feature map corresponding to this period load type, this may be implemented based on the initial resource usage data within the target time period. However, since a lot of resource usage data are included within the target time interval, and different time nodes correspond to different resource usage values, in order to be able to quickly and precisely determine resource usage data corresponding to this period load type, and achieve that resource allocation may be accurately completed at a resource allocation stage, the initial resource usage data may be sampling processed at this time, so as to obtain a plurality of initial resource usage values according to a sampling processing result, and then the plurality of initial resource usage values are processed according to an attenuation value, such that the resource usage data corresponding to the period corresponding to the period load type may be obtained according to the processing result.

It should be noted that when determining the short-period resource usage data, actually initial resource usage values corresponding to different time nodes within the target time interval are counted. That is, after initial resource usage data is sampled at each time node, resource usage condition at each time node is determined, then an initial resource usage value corresponding to each time node is determined based on a preset histogram and the resource usage condition at each time node, and each initial resource usage value is processed in batch according to a preset half-life, such that the short-period resource usage data corresponding to the load type may be obtained.

For example, if the target time interval is 3 minutes and a half-life period is 20 seconds, then resource usage values within the latest nine 20-second need to be merged. In the merging course, the closer an initial resource usage value is to a statistical time node, the greater its corresponding weight; or conversely, the smaller the weight, thereby guaranteeing that the short-period resource usage data obtained finally is closer to real data, and effectively improving the rationality of subsequent resource allocation.

Next, proceed to step S2046. At step S2046, the short-period resource feature map corresponding to the short-period load type is constructed based on the short-period resource usage data.

In an embodiment, after the short-period resource usage data is obtained above, the short-period resource feature map corresponding to the short-period load type may be constructed according to the short-period resource usage data, so as to facilitate subsequent implementation of resource allocation for the work loads of the short-period load type in conjunction with the short-period resource feature map.

In another aspect, it is also necessary to construct the long-period resource feature map corresponding to the long-period load type based on the resource usage data. At this time, due to characteristics of the long-period load type, work loads under this type have a longer lifecycle and require stable resource support. Therefore, it is necessary to construct the long-period resource feature map with features of work loads in a long-period dimension. In this embodiment, the specific implementation is as follows: determining a period value corresponding to the long-period load type, and determining long-period resource usage data from the resource usage data according to the period value; and based on the long-period resource usage data, constructing the long-period resource feature map corresponding to the long-period load type.

In an embodiment, the period value specifically may refer to a period length needed to construct the long-period resource feature map corresponding to the long-period load type. Correspondingly, the long-period resource usage data specifically refers to data of resource usage condition corresponding to the long-period load type within an interval corresponding to the period value.

Based on this, due to characteristics of the long-period load type, i.e., its long lifecycle and relatively stable resources needed, it is therefore necessary to first determine a period value corresponding to the long-period load type, then determine the long-period resource usage data from the resource usage data according to the period value, and construct, on this basis, the long-period resource feature map of the long-period load type, so as to facilitate subsequent implementation of resource allocation from a perspective of resource utilization rate.

Taking as an example a real-time response service being a work load of the long-period load type, and a model training task being a work load of the long-period load type, courses of constructing the long-period resource feature map and the short-period resource feature map are described.

Based on this, resource usage data corresponding to work loads is acquired at a server side, then initial resource usage data of past 30 days is selected from the resource usage data, then the initial resource usage data is processed based on a time attenuation sliding window statistical algorithm, and a short-period resource image corresponding to the short-period load type is created according to a processing result. Further, since the short-period resource image reflects resource usage expression of a work load of real-time response service, in order to meet resource needs of real-time AI and streaming computing tasks, it is also necessary, on this basis, to allocate resources to a work load of the long-period load type. At this time, a period value may be determined, then long-period resource usage data is determined from the resource usage data according to the period value, so as to reflect resource usage condition of long-lifecycle tasks (e.g., a model training task) within the period value, and then, on this basis, a long-period resource feature map corresponding to the long online real-time load type is constructed, which may be applied to subsequent resource allocation processing.

In summary, by means of constructing the long-period resource feature map and the short-period resource feature map, which serves as a foundation for subsequent allocation of resources, the rationality of resource allocation may be further guaranteed. Meanwhile, considering impacts of characteristics of different load types, the resource utilization rate will be further guaranteed subsequently, thereby maintaining resources rationally and efficiently and avoiding resource waste.

Next, proceed to step S206. At step S206, short-period resources are allocated for the short-period load type from resources to be allocated according to the short-period resource feature map.

In an embodiment, after completion of the above construction of the short-period resource feature map and the long-period resource feature map, since the short-period resource feature map corresponds to the short-period load type, and since tasks corresponding to the short-period load type are all tasks of a batch-processing type, in other words, this type of work loads need to constantly submit requests, and resources need to be continuously allocated to run the requests from this type of work loads, short-period resources therefore need to be allocated directly for the short-period load type from resources to be allocated, so that the running of work loads of the short-period load type may be supported and implemented through the short-period resources.

The resources to be allocated specifically refer to all computing resources that the data center can allocate to work loads. Correspondingly, the short-period resources specifically refer to resources allocated to a work load of the short-period load type. In other words, when processing a request from a work load of the short-period load type, the short-period resources will be called to support running of the request.

In an embodiment, when allocating short-period resources for the short-period load type, since the short-period resource feature map reflects an image of resource usage condition of the short-period load type, resource allocation may be implemented in conjunction with the short-period resource feature map, which not only may guarantee the utilization rate of the resources, but also can achieve load balancing.

In this embodiment, the specific implementation is as follows: determining a short-period resource feature value according to the short-period resource feature map; utilizing the short-period resource feature value to process a work load of the short-period load type, determining short-period resource allocation information according to a processing result; and according to the short-period resource allocation information, allocating, from the resources to be allocated, the short-period resources for the short-period load type.

In an embodiment, the short-period resource feature value specifically may refer to a peak value in the short-period resource feature map. Correspondingly, the short-period resource allocation information specifically may refer to information that needs to be adhered to when performing resource allocation for the short-period load type.

Based on this, since what is focused on is computing power in this period of time when short-lifecycle resources are used, S_{avg} is employed when determining short-lifecycle resource features, thereby fully guaranteeing certainty of running of the short-lifecycle task resources without leading to waste in the resource allocation.

In summary, by means of employing the short-period resource feature value to determine resource allocation information, this not only may guarantee that subsequently allocated short-period resources may effectively support a work load of the short-period load type, but also can improve the rationality of the resource allocation and avoid resource waste caused by over-allocation of the resources.

In an embodiment, in order to be able to support work loads of different classes, work loads of the short-period load type may also be divided into two sub-load types, and the short-period resource allocation is implemented on this basis, which is specifically implemented from steps S2062 to S2066 as below.
At step S2062, first resource allocation information corresponding to a first sub-load type and second resource allocation information corresponding to a second sub-load type are determined according to the short-period resource feature map, wherein the first sub-load type and the second sub-load type are included in the short-period load type.

In an embodiment, the first sub-load type specifically may refer to work loads with higher requirements for real time, such as services obtained by clicking on controls in a shopping APP. The second sub-load type specifically may refer to work loads with higher requirements for offline processing, such as daily-level big data reports. Correspondingly, the first resource allocation information specifically refers to information to perform resource allocation for the first sub-load type, and the second resource allocation information specifically refers to information to perform resource allocation for the second sub-load type.

Based on this, when the short-period resource feature map is obtained, since the first sub-load type needs to apply resources at any moment, it has the highest priority, and the first resource allocation information corresponding to the first sub-load type may be determined directly according to the short-period resource feature map. Meanwhile, since the second sub-load type uses resources at a daily level, and a usage time interval is also relatively stable, its priority is lower than that of the first sub-load type. In order to be able to improve the resource utilization rate, the second resource allocation information may be determined in conjunction with other information of the short-period resource feature map. In this embodiment, the specific implementation is as follows: according to the short-period resource feature map, determining resource application information and resource usage information corresponding to the short-period load type; according to the resource usage information, performing resource evaluation on the short-period load type to obtain resource evaluation information; and based on the resource evaluation information and the resource application information, determining the second resource allocation information corresponding to the second sub-load type.

In an embodiment, the resource application information specifically may refer to information corresponding to resources applied for by a work load of the first sub-load type prior to running. The resource usage information specifically may refer to information corresponding to resources used by the work load of the first sub-load type during running. The resource evaluation information specifically may refer to information corresponding to resources that can support the running of the work load, which are predicted according to the resources used by the work load during running. Applied resources corresponding to the resource application information are larger than evaluated resources corresponding to the resource evaluation information, and the evaluated resources corresponding to the resource evaluation information are larger than used resources corresponding to the resource usage information.

Based on this, considering that a work load of the second sub-load type has a priority lower than that of a work load of the first sub-load type, and also has a lower resource usage frequency, in order to improve the resource utilization rate, for the work load of the first sub-load type, resource application information and resource usage information corresponding to the first sub-load type therefore may be determined through the short-period resource feature map, then available resources for the first sub-load type are evaluated according to the resource usage information to obtain resource evaluation information, and then the second resource allocation information corresponding to the second sub-load type may be determined in conjunction with the resource evaluation information and the resource application information, which is used to subsequently implement resource allocation for the first sub-load type and the second sub-load type included in the short-period load type in conjunction with the first resource allocation information.

It should be noted that when calculating the resource evaluation information, prediction may be performed according to a resource utilization rate of the work load of the first sub-load type within the target time interval T, and a value of T is a product of set probability values for a running duration of the second sub load type, so as to guarantee the rationality of resource allocation.

In summary, the second allocation information of the second sub-load type is determined by combining the resource application information, the resource usage information and the resource evaluation information, which may not only improve the resource utilization rate, but also can reduce an impact on the work load of the first sub-load type, thereby effectively guaranteeing the resource balance of the data center.

Next, proceed to step S2064. At step S2064, according to the first resource allocation information, first short-period resources are allocated for the first sub-load type from the resources to be allocated.
At step S2066, according to the second resource allocation information, second short-period resources are allocated for the second sub-load type from the first short-period resources.

In an embodiment, after the first resource allocation information and the second resource allocation information are obtained above, considering that the first sub-load type has a priority greater than that of the second sub-load type, resources corresponding to the first sub-load type therefore may be selected from the resources to be allocated and allocated to the first sub-load type according to the first resource allocation information, that is, first short-period resources are allocated for use by the work load of the first sub-load type.

In an embodiment, resources corresponding to the second sub-load type may be selected from the first short-period resources and allocated to the second sub-load type according to the second resource allocation information, that is, second short-period resources are allocated for use by the work load of the second sub-load type.

In other words, the second short-period resources that can be governed by the second sub-load type belong to a part of the first short-period resources, and this part is a part that will not be utilized when the work load is running, thereby improving the resource utilization rate and avoiding the occurrence of a resource waste problem.

To make an explanation with examples, services provided at a server side are classified into four categories, namely Prod (real-time response service), Mid (long-period real-time computing task), Batch (offline analysis task) and Free (emergency task). The priority is that Prod>Mid>Batch>Free. Based on this, resource usage data corresponding to different types of work loads is obtained, a resource image corresponding to Prod is constructed through the resource usage data, and according to a resource image value of the resource image, it is determined that resources allocatable to Prod meet Σᵢ request (Prod)≤Allocable_{node}, in other words, resources that can be allocated to Prod at each node in the data center will not be oversold. This may guarantee that resources of the entire cluster will not be oversold, thereby guaranteeing resource balancing.

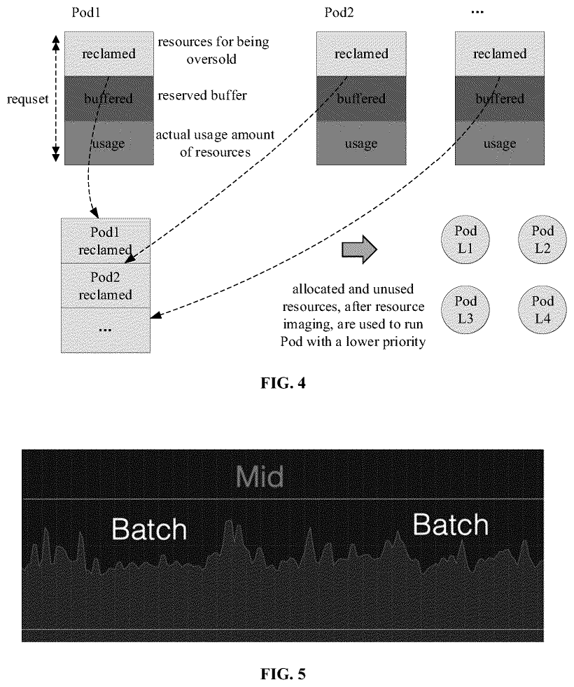

In an embodiment, by referring to the resource image corresponding to Prod shown in FIG. 3, where “limit” is a curve of resources applied for by a work load, “usage” is a curve of resources actually applied by the work load, and a difference between the two is resources applied for but unused. In order to fully utilize this part of allocated but unused resources without affecting the running of the work load, available resources of this part may be evaluated at this time according to actually used resources to obtain the resource evaluation information, which is the curve corresponding to “reservation” in FIG. 3. Resources between “limit” and “reservation” are resources that can be allocated to Batch without affecting Prod. In other words, the resources allocated to Batch meet Allocable=Σ reclaimed (Prod).

In an embodiment, according to the above content, it may be determined that the first short-period resources allocated to Prod are schedulable resources in the node, and the second short-period resources allocable to Batch are unutilized resources in the first short-period resources, so as to achieve that, during running of work loads, selecting corresponding resources according to the type of the work loads to run corresponding requests.

In addition, after a request is acquired from a work load belonging to Prod, resource usage condition in Pod1-Podn is determined through load balancing, as shown in FIG. 4, where “usage” characterizes a used part of resources, “buffered” represents a reserved part of resources, and “reclaimed” characterizes an oversold part of resources. Based on this, there are oversold resources in each Pod. In other words, when a request is received from a work load belonging to Batch, this type of request may be run through “reclaimed” in Pod1 to Podn, that is, resources that have been allocated to Prod but not used, which, after resource imaging, are used to run requests with a lower priority than Prod, namely requests Pod_L1, Pod_L2, Pod_L3 and Pod_L4 belonging to Batch type, so as to guarantee the utilization rate of the resources.

In summary, by allocating the second short-period resources for the second sub-load type on the basis of the first short-period resources, not only may ameliorate resource management environment, but also can avoid waste of resources applied for, thereby effectively improving the resource utilization rate.

Besides the above, considering a scenario that allocation of resources in a node cluster is not sufficient, in order to enable a work load of the second sub-load type also to be fully scheduled on a resource node of the first load type, controllable resources may be further taken into account. That is, the second short-period resources corresponding to the second sub-load type are not only unused resources in the first short-period resources, but also may be emergency resources for guarantee. In this embodiment, the specific implementation is as follows: acquiring mobility resources and a mobility weight corresponding to the mobility resources; generating third resource allocation information according to the mobility resources and the mobility weight, and determining fourth resource allocation information according to the resource evaluation information and the resource application information; and based on the third resource allocation information and the fourth resource allocation information, determining the second resource allocation information corresponding to the second sub-load type.

In an embodiment, the mobility resources specifically may refer to resources that can be called to cope with a sudden event. Correspondingly, the mobility weight is determined according to a frequency of using the mobility resources by work loads of the second sub-load type, where the higher the frequency, the greater the mobility weight, indicating that the probability of the mobility resources being used is greater, and further indicating that more mobility resources need to be allocated for use by the work loads of the second sub-load type. Correspondingly, the third resource allocation information specifically may refer to resource information in the mobility resources that can be allocated to the second sub-load type, and the fourth resource allocation information specifically refers to resource information in the first short-period resources that can be allocated to the second sub-load type.

Based on this, in order to be able to guarantee that allocable resources for a work load of the second sub-load type are sufficient and have a higher utilization rate, motility resources and its corresponding motility weight may be acquired, so as to determine, according to the motility resources and the motility weight, third resource allocation information corresponding to resources that can be allocated to the second sub-load type. Meanwhile, fourth resource allocation information is determined according to the resource evaluation information and the resource application information, and finally the second resource allocation information corresponding to the second sub-load type may be determined by integrating the third resource allocation information and the fourth resource allocation information. This second resource allocation information includes allocation details of the mobility resources and allocation details of the first short-period resources, so as to support running of the work loads of the second sub-load type. It should be noted that the value of the mobility weight may be determined based on an average running duration of the work loads of the second sub-load type and a frequency of scheduling the mobility resources by work loads of the first sub-load type.

Following the above example, after determining short-period resources that can be allocated to Batch in the first short-period resources corresponding to Prod, additional resources that may be allocated to Batch may also be calculated according to emergency resources corresponding to Free and its corresponding weight, and then these two parts of resources are integrated, such that the second short-period resources that can be allocated to Batch may be determined, so as to support running of this type of work load.

In summary, by adding the motility resources to the second short-period resources, not only may avoid a problem of insufficient resource allocation, but also can guarantee that the work loads of the second sub-load type may be allocated with the first short-period resources corresponding to the first sub-load type, thereby improving a utilization rate of the resources and avoiding useless consumption caused by long-time idleness of the resources.

Next, proceed to step S208. At step S208, long-period resources are allocated for the long-period load type from the short-period resources according to the long-period resource feature map.

In an embodiment, after resource allocation to the short-period load type is completed above, in order to be able to improve the resource utilization rate, long-period resources may be allocated for the long-period load type from the short-period resources according to the long-term resource feature map. In other words, the long-period resources allocated to the long-period load type is a part of the short-period resources, thereby guaranteeing that characteristics of the long-period load type may be fully considered when allocating the long-period resources, and potentially unused resources in the short-period resources may be fully utilized, thereby effectively improving the resource utilization rate.

In an embodiment, in a course of allocating long-period resources for the long-period load type, in order to be able to improve the rationality of resource allocation, this may be implemented in conjunction with the long-period feature map corresponding to the long-period load type. The specific implementation is as follows: determining a long-period resource feature value according to the long-period resource feature map; determining long-period resource allocation information based on the long-period resource feature value; and according to the long-period resource allocation information, allocating, from the short-period resources, the long-period resources for the long-period load type.

In an embodiment, the long-period resource feature value specifically refers to a numerical value that characterizes resource usage condition of a work load of the long-period load type, and the long-period resource allocation information specifically refers to information to perform resource allocation for the long-period load type.

Based on this, the short-period load type has fully coped with short-lifecycle computing tasks, yet with the widespread application of AI technology, AI training inference is not a short-lifecycle task and has higher requirements for resource stability during running as compared with work loads of the short-period load type, that is, it needs a long-term and stable resource. Therefore, if long-period resources need to be allocated for a long-period load task, it is necessary to determine a long-period resource feature value based on the long-period resource feature map, then determine long-period resource allocation information based on the long-period resource feature value, and then according to the long-period resource allocation information, allocate, from the short-period resources, the long-period resources for the long-period load type. In other words, the long-period resources are a part of the short-period resources.

Following the above example, when resources need to be allocated for Mid, considering the resource utilization rate, a resource image of Mid may be obtained based on long-period resource usage condition of the Prod work load, and a period length may be determined according to characteristics of the work load, that is, T_{mid}∈{8,31}, which ensures that a running period of a Mid work load may cover a weekly or monthly time period of the Prod work load. In other words, resource allocation for Mid needs to meet Allocable (Mid)=Σᵢ[request (Prodᵢ)−S_{T} (Prodᵢ), where S_{T} (Prodᵢ) represents a long-period resource image value of the Prod work load, which is the schematic diagram shown in FIG. 5. The Mid work load may long occupy allocated and unused resources during running; resource spot reading is performed through S_{T} (Prodᵢ) obtained via the long-period resource image value, such that the resource stability of Mid is very close to that of Prod resources, which is used to support long-lifecycle tasks.

It should be noted that when work loads belonging to Prod, Mid or Batch make requests at the same time, if resources may be allocated rationally, they may run at the same time; and if the resources cannot be rationally allocated, they may be processed sequentially in order of priority, so as to improve the resource utilization rate.

In summary, by using feature image of resources of an online real-time interactive task of the Prod type, not only can the short-period resources be used to implement overselling allocation again of the allocated and unused resources for the long-period load type, thereby improving the resource utilization rate, but also it can guarantee that resources with higher stability are used by the work load of the long-period load type during running, so as to support sustained running of the work load of the long-period load type.

In addition, considering that additional resources are needed in emergency scenarios to support running of a sudden work load, calling resources may also be provided additionally. In this embodiment, the specific implementation is as follows: acquiring system reserved resources; calculating calling resources according to the resources to be allocated, the short-period resources, and the system reserved resources, and creating a calling strategy corresponding to the calling resources; and for an emergency load type, allocating the calling resources and configuring the calling strategy.

In an embodiment, the system reserved resources specifically may refer to resources that cannot be used, the calling resources specifically may refer to resources that may support additional governance for emergency scenarios, and the calling strategy may limit usage scenarios of the calling resources to avoid the calling resources from being abused.

Based on this, although the resource allocation for the short-period load type and the long-period load type has covered a wide range of scenarios and may meet demands of different work loads for computing resources in respective scenarios. In order to be able to support emergency needs, calling resources may also be provided, in other words, resources that may be used at any time to support a sudden event. This part of resources may be calculated and determined based on the resources to be allocated, the short-period resources and the system reserved resources, and in order to be able to improve the stability of the calling resources, a calling strategy for the same is further set, so as to achieve allocation of the calling resources for the emergency load type and configure the calling strategy.

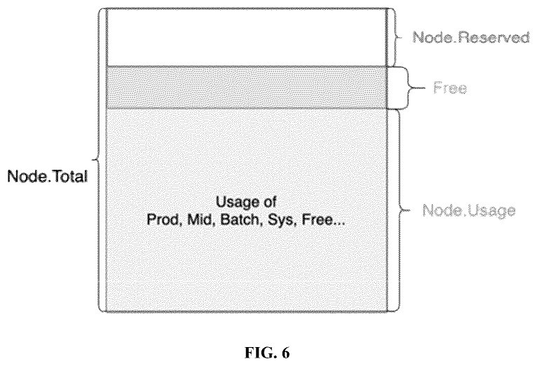

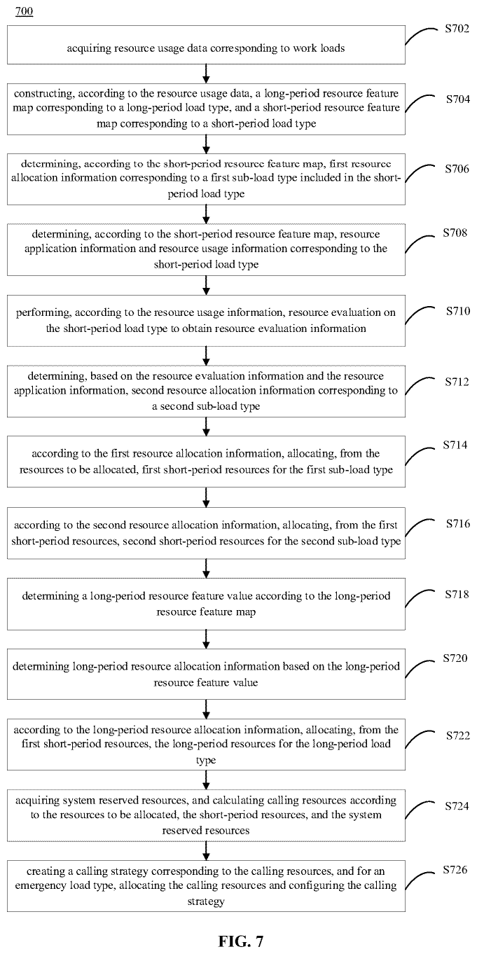

Following the above example, a combination of Prod+Mid+Batch has been able to fully use the resources in the cluster and meet demands of the work loads for computing resources in their respective scenarios. In order to cope with a sudden scenario, calling resources corresponding to Free may be provided additionally. By referring to the schematic diagram shown in FIG. 6, resource scheduling is performed for Free based on an actual utilization rate of the node, which meets Allocable (Free)=min(Allocable_{Node}−Reserved_{System}−Usage_{Node}, HardLimit_{Free}). In other words, the remaining resources in the node all may be used as the calling resources for Free, and it may set that resources corresponding to Free at the same node may not be called by too many tasks.

In summary, by providing the calling resources and the calling strategy, sudden scenarios may be coped with, which not only may improve the resource utilization rate, but also can facilitate resource maintenance.

In an embodiment, after resource allocation is completed, if a request corresponding to a target application is received, corresponding resources may be selected for allocation based on the type of the target application, so as to support running of the request. In this embodiment, the specific implementation is as follows: acquiring an application request corresponding to a target application, and determining a target load type corresponding to the application request; loading the application request to the short-period resources in a case where the target load type is the short-period load type; and loading the application request to the long-period resources in a case where the target load type is the long-period load type.

In an embodiment, the target application specifically may refer to an application that needs to be supported and run by computing resources at a current moment. Correspondingly, the application request is a request that needs to be responded to and run through resources.

Based on this, after the application request corresponding to the target application is received, it is possible to first determine the target load type corresponding to the application request. If the target load type belongs to the short-period load type, this means that the short-period resources need to be used to run the application request, and the application request may be loaded to the short-period resources; and if the target load type belongs to the long-period load type, this means that the long-period resources need to be used to run the application request, and the application request may be loaded to the long-period resources.

According to the resource allocation method provided in the present application, after resource usage data corresponding to work loads is acquired, it is possible to construct, on this basis, a long-period resource feature map corresponding to a long-period load type and a short-period resource feature map corresponding to a short-period load type, thereby achieving that resource demands of different types of work loads are reflected by resource feature maps, then short-period resources are allocated for the short-period load type according to the short-period resource feature map, and after resources are all allocated, long-period resources are oversold for the long-period task load type according to the long-period resource feature map; and achieving that resource allocation of any task is supported by unification processing, which may not only ensure requirements for resource certainty of various services, but also improve the resource utilization rate of a data center by means of resource overselling, thereby effectively reducing losses brought about by resource waste.

The resource allocation method will be further explained below with reference to FIG. 7 by taking application of the resource allocation method provided in the present application in a scenario of resource allocation in a data center as an example. FIG. 7 shows a flow chart of a processing course of a resource allocation method 700 according to an embodiment of the present application, which specifically comprises the following steps S702 to S726.
At step S702, resource usage data corresponding to work loads is acquired.
At step S704, a long-period resource feature map corresponding to a long-period load type and a short-period resource feature map corresponding to a short-period load type are constructed according to the resource usage data.
At step S706, first resource allocation information corresponding to a first sub-load type included in the short-period load type is determined according to the short-period resource feature map.
At step S708, resource application information and resource usage information corresponding to the short-period load type are determined according to the short-period resource feature map.
At step S710, according to the resource usage information, resource evaluation is performed on the short-period load type to obtain resource evaluation information.
At step S712, second resource allocation information corresponding to the second sub-load type is determined based on the resource evaluation information and the resource application information.
At step S714, according to the first resource allocation information, first short-period resources are allocated for the first sub-load type from resources to be allocated.
At step S716, according to the second resource allocation information, second short-period resources are allocated for the second sub-load type from the first short-period resources.
At step S718, a long-period resource feature value is determined according to the long-period resource feature map.
At step S720, long-period resource allocation information is determined based on the long-period resource feature value.
At step S722, long-period resources are allocated for the long-period load type from the first short-period resources according to the long-period resource allocation information.
At step S724, system reserved resources are acquired, and calling resources are calculated according to the resources to be allocated, the short-period resources, and the system reserved resources.
At step S726, a calling strategy corresponding to the calling resources is created, and the calling resources are allocated and the calling strategy is configured for an emergency load type.

In summary, according to the resource allocation method provided in the present application, after resource usage data corresponding to work loads is acquired, it is possible to construct, on this basis, a long-period resource feature map corresponding to a long-period load type and a short-period resource feature map corresponding to a short-period load type, thereby achieving that resource demands of different types of work loads are reflected by resource feature maps, then short-period resources are allocated for the short-period load type according to the short-period resource feature map, and after resources are all allocated, long-period resources are oversold for the long-period task load type according to the long-period resource feature map; and achieving that resource allocation of any task is supported by unification processing, which may not only ensure requirements for resource certainty of various services, but also improve the resource utilization rate of a data center by means of resource overselling, thereby effectively reducing losses brought about by resource waste.

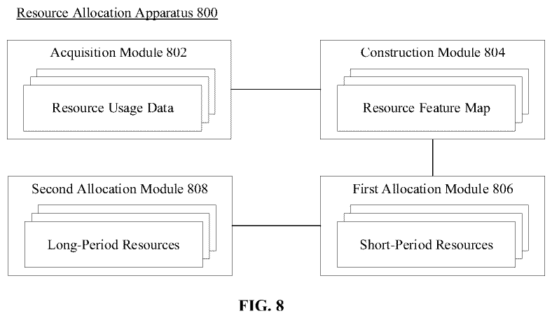

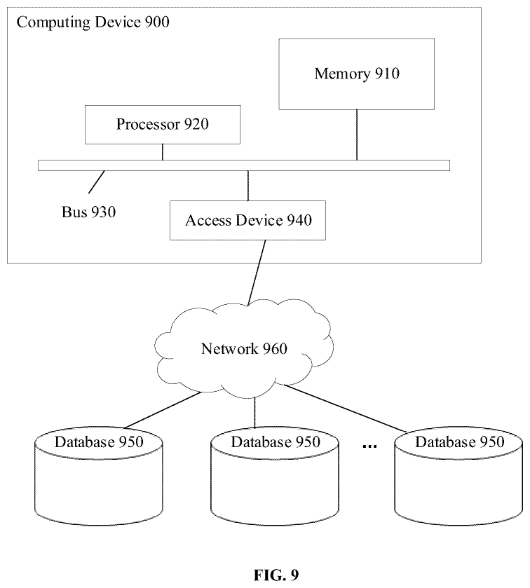

Corresponding to the above embodiments of the resource allocation methods, the present application further provides an embodiment of a resource allocation apparatus 800. FIG. 8 shows a structural schematic diagram of a resource allocation apparatus provided in an embodiment of the present application. As shown in FIG. 8, this apparatus comprises: an acquisition module 802, a construction module 804, a first allocation module 806 and a second allocation module 808.

Acquisition module 802 is configured to acquire resource usage data corresponding to work loads.

Construction module 804 is configured to construct, according to the resource usage data, a long-period resource feature map corresponding to a long-period load type, and a short-period resource feature map corresponding to a short-period load type.

First allocation module 806 is configured to, according to the short-period resource feature map, allocate, from resources to be allocated, short-period resources for the short-period load type.

Second allocation module 808 is configured to, according to the long-period resource feature map, allocate, from the short-period resources, long-period resources for the long-period load type.

In an embodiment, construction module 804 is further configured to: select, from the resource usage data, initial resource usage data corresponding to a target time interval; process the initial resource usage data according to a preset attenuation strategy to obtain short-period resource usage data; and based on the short-period resource usage data, construct the short-period resource feature map corresponding to the short-period load type.

In an embodiment, first allocation module 806 is further configured to: determine a short-period resource feature value according to the short-period resource feature map; utilize the short-period resource feature value to process a work load of the short-period load type, and determine short-period resource allocation information according to a processing result; and according to the short-period resource allocation information, allocate, from the resources to be allocated, the short-period resources for the short-period load type.

In an embodiment, construction module 804 is further configured to: determine a period value corresponding to the long-period load type, and determine long-period resource usage data from the resource usage data according to the period value; and based on the long-period resource usage data, construct the long-period resource feature map corresponding to the long-period load type.

In an embodiment, second allocation module 808 is further configured to: determine a long-period resource feature value according to the long-period resource feature map; determine long-period resource allocation information based on the long-period resource feature value; and according to the long-period resource allocation information, allocate, from the short-period resources, the long-period resources for the long-period load type.

In an embodiment, construction module 804 is further configured to: according to the short-period resource feature map, determine first resource allocation information corresponding to a first sub-load type and second resource allocation information corresponding to a second sub-load type, wherein the first sub-load type and the second sub-load type are included in the short-period load type; according to the first resource allocation information, allocate, from the resources to be allocated, first short-period resources for the first sub-load type; and according to the second resource allocation information, allocate, from the first short-period resources, second short-period resources for the second sub-load type.

In an embodiment, construction module 804 is further configured to: according to the short-period resource feature map, determine resource application information and resource usage information corresponding to the short-period load type; according to the resource usage information, perform resource evaluation on the short-period load type to obtain resource evaluation information; and based on the resource evaluation information and the resource application information, determine the second resource allocation information corresponding to the second sub-load type.

In an embodiment, construction module 804 is further configured to: acquire mobility resources and a mobility weight corresponding to the mobility resources; generate third resource allocation information according to the mobility resources and the mobility weight, and determine fourth resource allocation information according to the resource evaluation information and the resource application information; and based on the third resource allocation information and the fourth resource allocation information, determine the second resource allocation information corresponding to the second sub-load type.

In an embodiment, construction module 804 is further configured to: perform sampling processing on the initial resource usage data at each time node in the target time interval to obtain a plurality of initial resource usage values; determine an attenuation value corresponding to the target time interval, and process the plurality of initial resource usage values according to the attenuation value; and determine the short-period resource usage data according to a processing result.

In an embodiment, the resource allocation apparatus further comprises: an emergency module, configured to acquire system reserved resources; calculate calling resources according to the resources to be allocated, the short-period resources, and the system reserved resources, and create a calling strategy corresponding to the calling resources; and for an emergency load type, allocate the calling resources and configure the calling strategy.

In an embodiment, the resource allocation apparatus further comprises: a loading module, configured to acquire an application request corresponding to a target application, and determine a target load type corresponding to the application request; load the application request to the short-period resources in a case where the target load type is the short-period load type; and load the application request to the long-period resources in a case where the target load type is the long-period load type.

According to the resource allocation apparatus provided in the present application, after resource usage data corresponding to work loads is acquired, it is possible to construct, on this basis, a long-period resource feature map corresponding to a long-period load type and a short-period resource feature map corresponding to a short-period load type, thereby achieving that resource demands of different types of work loads are reflected by resource feature maps, then short-period resources are allocated for the short-period load type according to the short-period resource feature map, and after resources are all allocated, long-period resources are oversold for the long-period task load type according to the long-period resource feature map; and achieving that resource allocation of any task is supported by unification processing, which may not only ensure requirements for resource certainty of various services, but also improve the resource utilization rate of a data center by means of resource overselling, thereby effectively reducing losses brought about by resource waste.

Described above is a schematic solution of a resource allocation apparatus according to an embodiment of the present application. It should be noted that the technical solution of this resource allocation apparatus has one and the same concept as the technical solution of the resource allocation method described above. Any details not detailed in the technical solution of the resource allocation apparatus may refer to the description of the technical solution of the resource allocation method described above.

FIG. 9 shows a structural block diagram of a computing device 900 provided according to an embodiment of the present application. Parts of this computing device 900 include, but are not limited to, a memory 910 and a processor 920. Processor 920 and memory 910 are connected through a bus 930, and a database 950 is used for saving data.

Computing device 900 further comprises an access device 940 that enables computing device 900 to communicate via one or more networks 960. Examples of these networks include a public switched telephone network (PSTN), a local area network (LAN), a wide area network (WAN), a personal area network (PAN), or a combination of communication networks such as the Internet. Access device 940 may comprise one or more of any types of wired or wireless network interfaces (e.g., a network interface card (NIC)), such as an IEEE 802.11 wireless local area network (WLAN) wireless interface, a worldwide interoperability for microwave access (Wi-MAX) interface, an Ethernet interface, a universal serial bus (USB) interface, a cellular network interface, a Bluetooth interface, a near field communication (NFC) interface, etc.

In an embodiment, the above parts of computing device 900 and other parts not shown in FIG. 9 may also be connected to each other through, for example, a bus. It should be understood that the structural block diagram of the computing device shown in FIG. 9 is for illustrative purposes only and does not limit the scope of the present application. Those skilled in the art may add or replace other parts as needed.

Computing device 900 may be any type of stationary or mobile computing device, including a mobile computer or mobile computing device (e.g., a tablet computer, a personal digital assistant, a laptop computer, a notebook computer, a netbook, etc.), a mobile telephone (e.g., a smartphone), a wearable computing device (e.g., a smart watch, smart glasses, etc.) or other types of mobile devices, or stationary computing devices such as a desktop computer or PC. Computing device 900 may also be a mobile or stationary server.

Processor 920 is used for executing computer-executable instructions as below that, when executed by the processor, implement the steps of the above resource allocation method.

Described above is a schematic solution of the computing device in this embodiment. It should be noted that the technical solution of this computing device has one and the same concept as the technical solution of the resource allocation method described above. Any details not detailed in the technical solution of the computing device may refer to the description of the technical solution of the resource allocation method described above.

An embodiment of the present application further provides a computer-readable storage medium that stores computer-executable instructions that, when executed by a processor, implement the steps of the above resource allocation method.

Described above is a schematic solution of the computer-readable storage medium in this embodiment. It should be noted that the technical solution of this storage medium has one and the same concept as the technical solution of the resource allocation method described above. Any details not detailed in the description of the technical solution of the storage medium may refer to the description of the technical solution of the resource allocation method described above.

An embodiment of the present application further provides a computer program, wherein when the computer program is executed in a computer, the computer is caused to execute the steps of the resource allocation method described above.

Described above is a schematic solution of the computer program in this embodiment. It should be noted that the technical solution of this computer program has one and the same concept as the technical solution of the resource allocation method described above. Any details not detailed in the technical solution of the computer program may refer to the description of the technical solution of the resource allocation method described above.

Described above are particular embodiments of the present application. Other embodiments are within the scope of the attached claims. In some cases, actions or steps recorded in the claims may be executed in a different order than in the embodiments, and may still achieve the desired result. Additionally, the processes depicted in the drawings does not necessarily require a particular or continuous order to achieve the desired result. In some implementations, multitasking and parallel processing are also possible or may be advantageous.

The computer instructions include computer program codes, which may be in a form of source code or object code, an executable file, or some intermediate form. The computer-readable medium may include: any entity or apparatus capable of carrying the computer program code, a recording medium, a USB flash drive, a portable hard drive, a magnetic disc, an optical disc, a computer memory, a read-only memory (ROM), a random access memory (RAM), an electrical carrier signal, a telecommunications signal, and a software distribution medium. It should be noted that content contained in the computer-readable medium may be appropriately increased or decreased according to the requirements of legislation and patent practice in a jurisdiction. For example, in some jurisdictions, according to legislation and patent practice, a computer-readable medium does not include an electrical carrier signal or a telecommunication signal.

It should be noted that for the convenience of description, the method embodiments described precedingly are all expressed as combinations of a series of actions. However, those skilled in the art should be aware that the embodiments of the present application are not limited by the described action orders, because according to the embodiments of the present application, certain steps may proceed in other orders or at the same time. Furthermore, those skilled in the art should also be aware that the embodiments described in the present application are all exemplary embodiments, and the actions and modules involved are not all definitely necessary for the embodiments of the present application.

In the above embodiments, different focuses are put on their respective descriptions. For parts not detailed in a certain embodiment, reference may be made to the relevant descriptions of other embodiments.

The preferred embodiments disclosed above are merely used to help elaborate the present application. The optional embodiments neither exhaustively recite all the details, nor limit the present application, and these embodiments are merely specific implementations of the technical solutions of the present application. Obviously, according to the content of the embodiments of the present application, many modifications and changes may be conducted. The present application selects and specifically describes these embodiments in order to better explain the principles and practical applications of the embodiments of the present application, such that those skilled in the art can well understand and utilize the present application. The present application is limited only by the claims and their entire scope and equivalents.

1. A resource allocation method, comprising:
acquiring resource usage data corresponding to work loads;
constructing, according to the resource usage data, a long-period resource feature map corresponding to a long-period load type, and a short-period resource feature map corresponding to a short-period load type;
according to the short-period resource feature map, allocating, from resources to be allocated, short-period resources for the short-period load type; and
according to the long-period resource feature map, allocating, from the short-period resources, long-period resources for the long-period load type.

2. The resource allocation method according to claim 1, wherein the constructing, according to the resource usage data, the short-period resource feature map corresponding to the short-period load type comprises:
selecting, from the resource usage data, initial resource usage data corresponding to a target time interval;
processing the initial resource usage data according to a preset attenuation strategy to obtain short-period resource usage data; and
constructing, based on the short-period resource usage data, the short-period resource feature map corresponding to the short-period load type.

3. The resource allocation method according to claim 1 or 2, wherein according to the short-period resource feature map, allocating, from the resources to be allocated, the short-period resources for the short-period load type comprises:
determining a short-period resource feature value according to the short-period resource feature map;
utilizing the short-period resource feature value to process a work load of the short-period load type, and determining short-period resource allocation information according to a processing result; and
according to the short-period resource allocation information, allocating, from the resources to be allocated, the short-period resources for the short-period load type.

4. The resource allocation method according to claim 1, wherein the constructing, according to the resource usage data, the long-period resource feature map corresponding to the long-period load type comprises:
determining a period value corresponding to the long-period load type, and determining long-period resource usage data from the resource usage data according to the period value; and
constructing, based on the long-period resource usage data, the long-period resource feature map corresponding to the long-period load type.

5. The resource allocation method according to claim 1 of 4, wherein according to the long-period resource feature map, allocating, from the short-period resources, the long-period resources for the long-period load type comprises:
determining a long-period resource feature value according to the long-period resource feature map;
determining long-period resource allocation information based on the long-period resource feature value; and
according to the long-period resource allocation information, allocating, from the short-period resources, the long-period resources for the long-period load type.

6. The resource allocation method according to claim 1, wherein according to the short-period resource feature map, allocating, from the resources to be allocated, the short-period resources for the short-period load type comprises:
determining, according to the short-period resource feature map, first resource allocation information corresponding to a first sub-load type and second resource allocation information corresponding to a second sub-load type, wherein the first sub-load type and the second sub-load type are included in the short-period load type;
according to the first resource allocation information, allocating, from the resources to be allocated, first short-period resources for the first sub-load type; and
according to the second resource allocation information, allocating, from the first short-period resources, second short-period resources for the second sub-load type.

7. The resource allocation method according to claim 6, wherein the second resource allocation information is determined by:
determining, according to the short-period resource feature map, resource application information and resource usage information corresponding to the short-period load type;
performing, according to the resource usage information, resource evaluation on the short-period load type to obtain resource evaluation information; and
determining, based on the resource evaluation information and the resource application information, the second resource allocation information corresponding to the second sub-load type.

8. The resource allocation method according to claim 7, wherein after executing the step of performing, according to the resource usage information, the resource evaluation on the short-period load type to obtain the resource evaluation information, the method further comprises:
acquiring mobility resources and a mobility weight corresponding to the mobility resources;
generating third resource allocation information according to the mobility resources and the mobility weight, and determining fourth resource allocation information according to the resource evaluation information and the resource application information; and
determining, based on the third resource allocation information and the fourth resource allocation information, the second resource allocation information corresponding to the second sub-load type.

9. The resource allocation method according to claim 2, wherein the processing the initial resource usage data according to the preset attenuation strategy to obtain the short-period resource usage data comprises:
performing sampling processing on the initial resource usage data at each time node in the target time interval to obtain a plurality of initial resource usage values;
determining an attenuation value corresponding to the target time interval, and processing the plurality of initial resource usage values according to the attenuation value; and
determining the short-period resource usage data according to a processing result.

10. The resource allocation method according to claim 1, further comprising:
acquiring system reserved resources;
calculating calling resources according to the resources to be allocated, the short-period resources, and the system reserved resources, and creating a calling strategy corresponding to the calling resources; and
for an emergency load type, allocating the calling resources and configuring the calling strategy.

11. The resource allocation method according to claim 1, wherein after executing the step of, according to the long-period resource feature map, allocating, from the short-period resources, the long-period resources for the long-period load type, the method further comprises:
acquiring an application request corresponding to a target application, and determining a target load type corresponding to the application request;
loading the application request to the short-period resources in a case where the target load type is the short-period load type; and
loading the application request to the long-period resources in a case where the target load type is the long-period load type.

12. (canceled)

13. A computing device, comprising:
a memory and a processor, wherein the memory is used for storing computer-executable instructions; and the processor is used for executing the computer-executable instructions, wherein when the computer-executable instructions are executed by the processor, the computing device implements operations of: acquiring resource usage data corresponding to work loads;
constructing, according to the resource usage data, a long-period resource feature map corresponding to a long-period load type, and a short-period resource feature map corresponding to a short-period load type;
according to the short-period resource feature map, allocating, from resources to be allocated, short-period resources for the short-period load type; and
according to the long-period resource feature map, allocating, from the short-period resources, long-period resources for the long-period load type.

14. A non-transitory computer-readable storage medium, which stores computer-executable instructions, wherein the computer-executable instructions, when executed by a processor, implement the resource allocation method according to claim 1.

15. The computing device according to claim 13, wherein when the computer-executable instructions are executed by the processor, the computing device implements operations of:
selecting, from the resource usage data, initial resource usage data corresponding to a target time interval;
processing the initial resource usage data according to a preset attenuation strategy to obtain short-period resource usage data; and
constructing, based on the short-period resource usage data, the short-period resource feature map corresponding to the short-period load type.

16. The computing device according to claim 13, wherein when the computer-executable instructions are executed by the processor, the computing device implements operations of:
determining a short-period resource feature value according to the short-period resource feature map;
utilizing the short-period resource feature value to process a work load of the short-period load type, and determining short-period resource allocation information according to a processing result; and
according to the short-period resource allocation information, allocating, from the resources to be allocated, the short-period resources for the short-period load type.

17. The computing device according to claim 13, wherein when the computer-executable instructions are executed by the processor, the computing device implements operations of:
determining a period value corresponding to the long-period load type, and determining long-period resource usage data from the resource usage data according to the period value; and
constructing, based on the long-period resource usage data, the long-period resource feature map corresponding to the long-period load type.

18. The computing device according to claim 13, wherein when the computer-executable instructions are executed by the processor, the computing device implements operations of:
determining a long-period resource feature value according to the long-period resource feature map;
determining long-period resource allocation information based on the long-period resource feature value; and
according to the long-period resource allocation information, allocating, from the short-period resources, the long-period resources for the long-period load type.

19. The computing device according to claim 13, wherein when the computer-executable instructions are executed by the processor, the computing device implements operations of:
determining, according to the short-period resource feature map, first resource allocation information corresponding to a first sub-load type and second resource allocation information corresponding to a second sub-load type, wherein the first sub-load type and the second sub-load type are included in the short-period load type;
according to the first resource allocation information, allocating, from the resources to be allocated, first short-period resources for the first sub-load type; and
according to the second resource allocation information, allocating, from the first short-period resources, second short-period resources for the second sub-load type.

20. The computing device according to claim 19, wherein when the computer-executable instructions are executed by the processor, the computing device implements operations of:
determining, according to the short-period resource feature map, resource application information and resource usage information corresponding to the short-period load type;
performing, according to the resource usage information, resource evaluation on the short-period load type to obtain resource evaluation information; and
determining, based on the resource evaluation information and the resource application information, the second resource allocation information corresponding to the second sub-load type.

21. The computing device according to claim 20, wherein when the computer-executable instructions are executed by the processor, the computing device implements operations of:
acquiring mobility resources and a mobility weight corresponding to the mobility resources;
generating third resource allocation information according to the mobility resources and the mobility weight, and determining fourth resource allocation information according to the resource evaluation information and the resource application information; and
determining, based on the third resource allocation information and the fourth resource allocation information, the second resource allocation information corresponding to the second sub-load type.
